(19) United States
(12) Patent Application Publication
(10) Pub. No.: US 2021/0064259 A1
(43) Pub. Date: Mar. 4, 2021

(54) MANAGING DATA OBJECTS

(71) Applicant: Hewlett Packard Enterprise Development LP, Houston, TX (US)

(72) Inventors: Kyle Sadlon, Whitinsville, MA (US); Jun Zhang, Upton, MA (US)

(21) Appl. No.: 16/552,691

(22) Filed: Aug. 27, 2019

(51) Int. Cl. G06F 3/06; H04L 9/06

(52) U.S. Cl. CPC G06F 3/0644; G06F 3/0619; G06F 3/067; H04L 9/0643

(57) ABSTRACT

Example implementations relate to on-disk cache tables. An example computer implemented method includes detecting, in a storage manager of a node of the distributed computer system, an input/output (I/O) request including a received object signature that uniquely identifies a data object stored in an object container of the distributed computer system; generating, from a first portion of the received object signature, a first mapping to a bucket in an on-disk cache table, the bucket including a predetermined number of slots in the on-disk cache table; generating, from a second portion of the received object signature, a second mapping to a starting slot of the bucket; and selectively managing the input/output (I/O) operation based upon an object signature value associated with the starting slot of the bucket. Recover operations are also provided.

### BACKGROUND

Computing systems may be connected over a network. Data may be transmitted between the computing systems over the network for various purposes, including processing, analysis, and storage. Computing systems may operate data virtualization platforms that manage data storage.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is a schematic illustration of a sequence for object retrieval in an example environment for data storage, according to embodiments.

FIG. 2 is a schematic illustration of an indexing scheme, in accordance with at least one embodiment.

FIG. 3A is a schematic illustration of a machine readable medium comprising instruction to implement input/output operations in a recoverable self-validating persistent cache, in accordance with an embodiment.

FIG. 3B is a flow diagram of a method to implement input/output operations in a recoverable self-validating persistent cache, in accordance with an embodiment.

FIG. 4 is a flow diagram of a method to implement input/output operations in a recoverable self-validating persistent cache, in accordance with an embodiment.

FIG. 5 is a schematic illustration of a machine readable medium comprising instruction to implement recovery operations in a recoverable self-validating persistent cache, in accordance with an embodiment.

FIG. 6 is a flow diagram of a method to implement recovery operations in a recoverable self-validating persistent cache, in accordance with an embodiment.

FIG. 7 is a block diagram illustrating a hyperconverged infrastructure (HCI) node that may represent the nodes of a distributed system in accordance with an embodiment.

### DETAILED DESCRIPTION

Described herein are exemplary systems and methods to implement a recoverable self-validating persistent object cache. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the examples.

Data may be stored on computing systems, such as servers, computer appliances, workstations, storage systems or storage arrays, converged or hyperconverged systems, or the like. Computing systems connected by a network may also be referred to as nodes. To store data, some computing systems may utilize a data virtualization platform that abstracts aspects of the physical storage hardware on which the data is physically stored (e.g., aspects such as addressing, configurations, etc.) and presents virtualized or logical storage to a user environment (e.g., to an operating system, applications, processes, etc.). The virtualized storage may be pooled from multiple storage hardware (e.g., hard disk drives, solid state drives, etc.) into a data store, out of which the virtualized or logical storage may be provided. The data virtualization platform may also provide data services such as deduplication, compression, replication, and the like.

In some implementations, the data virtualization platform may be instantiated, maintained, and managed by, at least in part, a virtual controller. A virtual controller may be a virtual machine (VM) executing on hardware resources, such as a processor and memory, with specialized processor-executable instructions to establish and maintain virtualized storage according to various examples described herein. In such instances, the virtual controller may be operating alongside guest virtual machines (also called client or user virtual machines), and on a same hypervisor or virtual machine manager as the guest virtual machines for example.

In some instances, the data virtualization platform may be object-based. An object-based data virtualization platform may differ from block level storage (e.g., implemented in storage area networks and presented via a storage protocol such as iSCSI or Fibre Channel) and file level storage (e.g., a virtual file system which manages data in a file hierarchy and is presented via a file protocol such as NFS or SMB/CIFS), although an object-based data virtualization platform may underlie block or file storage protocols in some implementations.

Components of an example object-based data virtualization platform may include a flat object store and one or more file system instances, among other things. Data may be stored as objects in the object store. For example, user accessible files and directories may be made up of multiple data objects. The object store may also store metadata objects related to the operation of the data virtualization platform, as will be described below. In an example, objects may be of a predetermined fixed size in the object store (e.g., 4 kib or 8 kib for data objects and 1 kib for metadata objects). Each object may be identified by a signature (also referred to as an object fingerprint), which, in some implementations, may include a cryptographic hash digest of the content of that object. An object index can correlate the signature of an object in the object store to a physical address of the object's content (i.e., a physical address on storage hardware such as disk).

A file system instance may refer to an organization of metadata objects and data objects that relate the data objects hierarchically to a root object. Thus, a file system instance may be identified by its root object. For example, the file system instance may be a Merkle tree or any other hierarchical arrangement (e.g., directed acyclic graphs, etc.). In the case of a hierarchical Merkle tree, data objects may be located at the lowest tree level of any branch (that is, most distant from the root object) and may also referred to as leaf data objects. A parent object includes as its content the signatures of child objects. For example, a parent object of leaf data objects is a metadata object that stores as its content the signatures of its child leaf data objects. The root object and other internal objects of a tree may also be metadata objects that store as content the signatures of respective child objects. A metadata object may be able to store a number of signatures that is at least equal to a branching factor of the hierarchical tree, so that it may hold the signatures of all of its child objects.

In example implementations, data of one or more guest virtual machines may be stored by one or more file system instances (e.g., one guest VM using storage from multiple file system instances, many guest VMs using storage from a file system instance, or any variation in between). In a particular example, each guest virtual machine may be associated with a respective file system instance on a one-to-one basis. The data virtualization platform may export a file protocol mount point (e.g., an NFS or SMB mount point) by which a guest virtual machine can access the storage provided by a file system instance via the namespace of the file protocol. In other implementations, a file system instance may be associated with and accessed for other units of storage, such as a block volume, a network attached storage share, a container volume, etc. In some implementations, objects in an object store may be referenced more than once in a single file system instance or may be referenced multiple times in file system instances. Thus, the multiply referenced object can be stored once but referenced many times to provide deduplication.

As mentioned above, an object index may be used correlate the signature of an object in the object store to a physical address of the object's content (i.e., a physical address on storage hardware such as disk). In some examples the object index can be stored in memory to provide fast access to the object index and, consequently, fast access to the content on storage. Hybrid storage systems employ a fast-tier storage media and a slow-tier storage media, which is commonly implemented as a disk. In hybrid storage systems some data objects may be copied from the slow-tier storage to memory or to the fast-tier storage to improve overall read performance of the storage system. Cached data objects are tracked by their signature using a mapping data structure that maps to both the fast-tier storage and the slow-tier storage media.

Incoming data access operations (i.e., read operations) may query the in-memory read cache and the larger on-disk read cache before accessing the object index to determine the location of a data object requested in the data access operation. If the cache query results in a cache miss, a copy of the requested object will be placed in the cache memory. If the in-memory cache is full, a data object in the cache will be evicted using a suitable technique (e.g., a least recently used (LRU) technique) and transferred to a staging area where the evicted data object is added to the on-disk cache by a background thread.

In large-scale storage systems the object index can grow quite large, thereby requiring a large amount of memory. Index object lookup operations are computationally expensive, particularly if the object index must be paged from on-disk storage. Recovering on-disk cached data after a system restart by validating each data object signature against the object index introduces overhead, and can cause object index contention, thereby delaying startup times.

Thus, it may be useful to provide a self-validating object cache for object-based storage systems. Subject matter described herein relates to an object cache that is efficient, recoverable, and self-validating. In one example an object cache table for the on-disk storage is sized to contain one entry for each addressable location on the disk, such that there is a direct mapping between an entry in the cache table and a storage location on disk. As described above, each data object is uniquely identified by an object signature. The signature may be used by a hash algorithm to place the object in the cache table. During cache recovery at startup, an object is read from a disk location and its signature is generated. The hash algorithm may reapplied to determine a cache table position. If the cache table position calculated in this manner matches the on-disk position of the object then the object is considered valid and its signature is placed in the cache table.

In some examples, a hash algorithm uses the first portion of the object signature to map into a bucket, which is a defined group of slots, in the cache table. The hash algorithm uses a second portion of the object signature to map to a starting location slot the bucket. Beginning at the starting location slot, a predetermined number of slots in the cache are scanned. If a slot in the predetermined number of slots is unoccupied, then the unoccupied slot is allocated to the data object. By contrast, if all the slots are occupied but one or more of the slots in the predetermined number of slots is not busy (i.e., there are no input/output operations acting on the slot) then the data in one of the non-busy slots is evicted and the slot is allocated to the data object. If all the slots in the predetermined number of slots are occupied and busy, then the data object is returned to a staging area and another attempt is made.

In a subsequent data access request, the hash algorithm is applied to the first portion of the object signature to map into a bucket in the cache table, and to the second portion of the object signature to map to a starting location slot in the bucket. The predetermined number of slots are then scanned to determine whether there is a data object in the predetermined number of slots having a signature that matches the signature received with the data access request. If a match is located, then the data object is retrieved from the object cache. If no match is located, then the data access request results in a cache miss and one or more cache miss algorithms may be implemented.

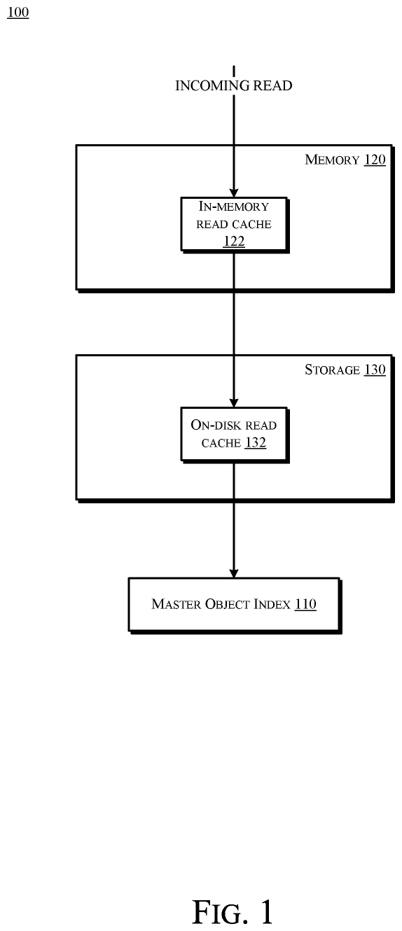

FIG. 1 is a schematic illustration of a sequence for object retrieval in an example environment for data storage, according to embodiments. Referring to FIG. 1, the environment 100 may comprise a master object index 110, memory 120 (e.g., DRAM) comprising an in-memory read cache 122, and a storage 130 that includes an on-disk read cache 132. In some examples the read cache 132 is separate from the storage 130, and may be carved out of one or more fast-tier storage devices. When an incoming read operation arrives, the operation is first directed to the in-memory read cache 122 to determine whether there is an object which has a signature that matches the signature in the read request. If an object with a matching signature is located in the in-memory read cache 122, then the read operation may return the object from the in-memory read cache.

By contrast, if there is not an object in the in-memory read cache 122 then the incoming read operation is directed to the on-disk read cache 132 to determine whether there is an object which has a signature that matches the signature in the read request. If an object with a matching signature is located in the on-disk read cache 132, then the read operation may return the object from the on-disk read cache 132.

By contrast, if there is not an object in the on-disk read cache 132 then the incoming read operation is directed to the master object index 110 to locate the object on the storage 130. Examples of the master object index 110 are described in greater detail below.

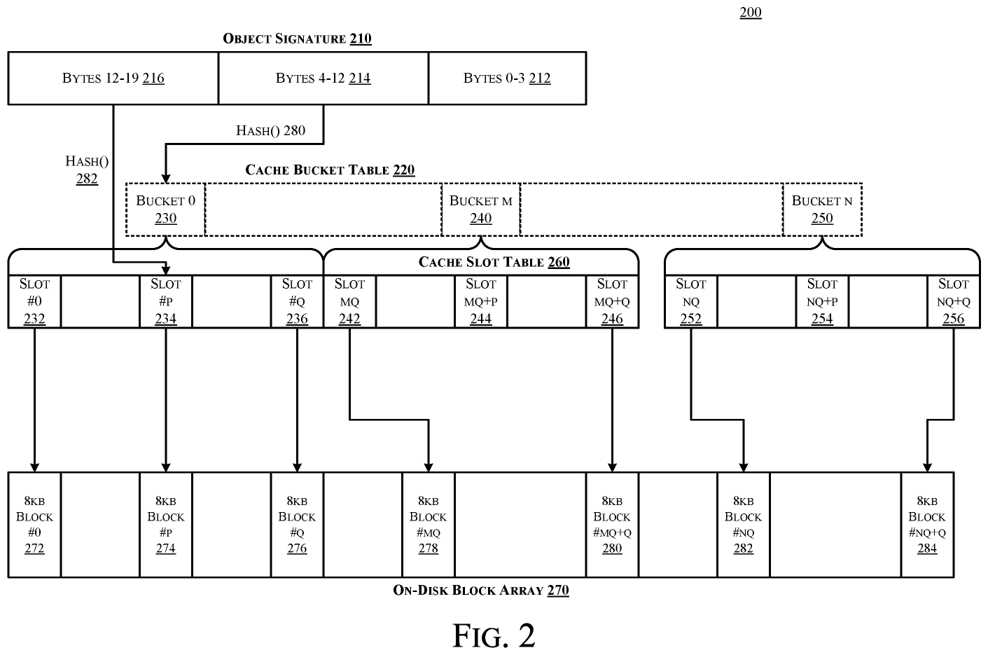

FIG. 2 is a schematic illustration of a mapping scheme, in accordance with at least one embodiment. Referring to FIG. 2, the mapping scheme utilizes an object signature 210, a cache bucket table 220, a cache slot table 260, and an on-disk block array 270. In some examples the cache bucket table 220 is a virtual object in the sense that the table exists as a mapping structure, and each bucket comprises 64 slots. The object signature 210 may be divided into multiple components. In the example depicted in FIG. 2 the object signature 210 is divided into three segments including a first segment 212 that includes bytes 0-3 of the object signature, a second segment 214 that includes bytes 4-12 of the object signature, and a third segment 216 that includes bytes 12-19 of the object signature. In other implementations the three segments may comprise different bytes or combinations of bytes. The cache memory may be divided into buckets, each of which includes a number of slots. The cache mapping scheme includes a cache bucket table 220 in which each bucket maps into a number of slots, identified by q. Thus, cache bucket 0 230 maps to a number of slots identified as slot #0 232, slot #p 234, and up through slot #q 236. Similarly, cache bucket m 240 maps to a number of slots identified as slot #mq 242, slot #mq+p 244, and up through slot #nq+q 246, and cache bucket n 250 maps to a number of slots identified as slot #nq 252, slot #nq+p 254, and up through slot #nq+q 256.

As described above, the cache memory is sized such that each entry in the cache slot table maps directly to a corresponding data block on the on-disk block array 270. Thus, slot #0 232 maps directly to data block 272, slot #p 234 maps directly to data block #p 272, slot q 236 maps directly to data block #q 276, slot #mq 242 maps directly to data block #mq 278, slot #mq+q 246 maps directly to data block #mq+q 278, slot #nq maps directly to data block #nq 282, and slot nq+q 256 maps directly to data block #nq+q 284.

As indicated in FIG. 2, a first hash function 280 (e.g., a SHA-256 hash) may be applied to the second segment 214 of the object signature to generate a first mapping to a bucket in a cache bucket table 220, and a second hash function 282 (e.g., a SHA-256 hash) may be applied to the third segment 216 of the object signature 210 to generate a second mapping to a specific slot within the bucket. Thus, the application of the first hash function 280 to segment 214 and the second hash function 282 to segment 216 maps the data object associated with the object signature 210 to a unique slot in the cache slot table 260. It will be recognized that, depending up the hash function, numerous signatures may map to the same slot in the cache slot table 260. In some instances, using a two-level hash mapping spreads out locking contention for resources in the cache slot table 260.

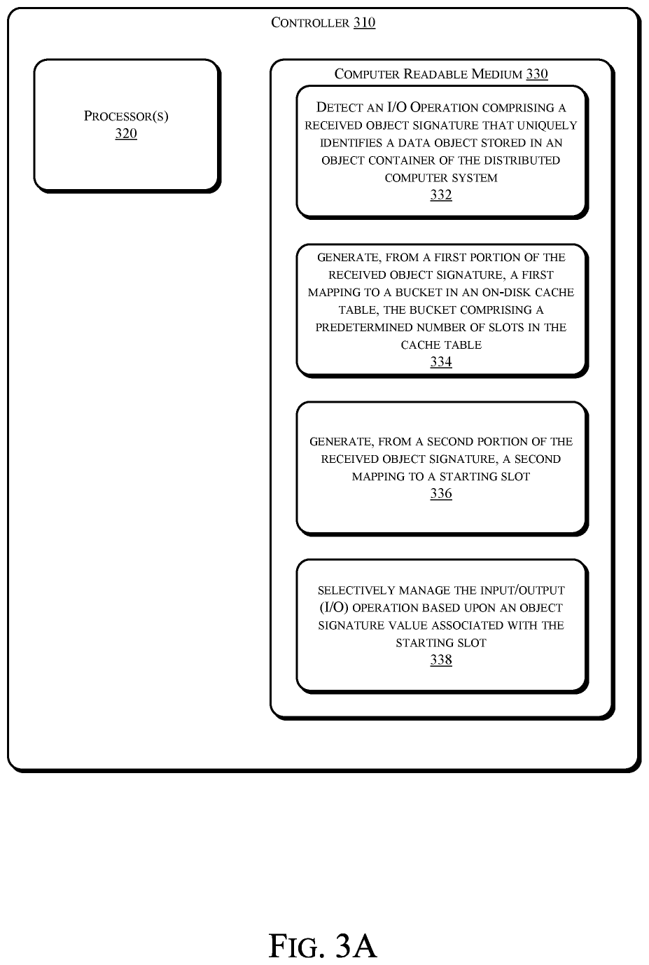

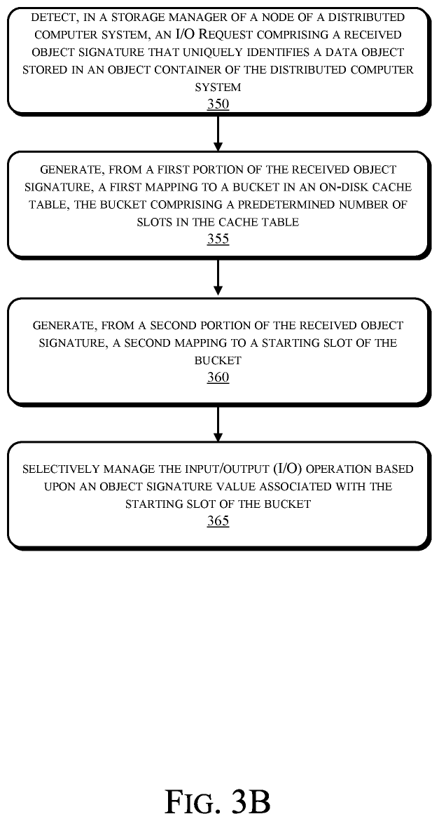

FIG. 3A is a schematic illustration of a machine-readable medium comprising instruction to implement a recoverable self-validating persistent cache, in accordance with an embodiment. More particularly, FIG. 3A depicts a controller 310 which comprises one or more processors 320 communicatively coupled to a non-transitory computer-readable medium 330 encoded with instructions 332, 334, 336, 338. The processor(s) 320 may be implemented as a general-purpose processing device, a programmable device (e.g., a field programmable gate array (FPGA)), or as a hard-wired processor (e.g., an application specific integrated circuit (ASIC)). In some examples the controller 310 may be incorporate into, or communicatively coupled to, a storage manager of a node of a distributed computer system.

Instructions 332, when executed, cause the processor(s) 320 to detect, in a storage manager of a node of the distributed computer system, an input/output (I/O) request comprising a received object signature that uniquely identifies a data object stored in an object container of the distributed computer system. In some examples the input/output (I/O) request may comprise a read request to read data associated with the data object. In some examples detecting the data access request may comprises receiving the data access request in the controller 310. While in other examples the data access request may be detected outside the controller 310.

Instruction 334, when executed, causes the processor(s) 320 to generate, from a first portion of the received object signature, a first mapping to a bucket in an on-disk cache table, the bucket comprising a predetermined number of slots in the cache table. As described above, in some examples the instructions may cause the processor(s) 320 to apply a first hash function 280 to a segment 214 of the object signature 210 to generate a mapping to a bucket in the cache bucket table 220.

Instruction 336, when executed, causes the processor(s) 320 to generate, from a second portion of the received object signature, a second mapping to a starting slot of the bucket. As described above, in some examples the instructions may cause the processor(s) 320 to apply a second hash function 282 to a segment 216 of the object signature 210 to generate a mapping to a starting slot within the bucket of the hash slot table.

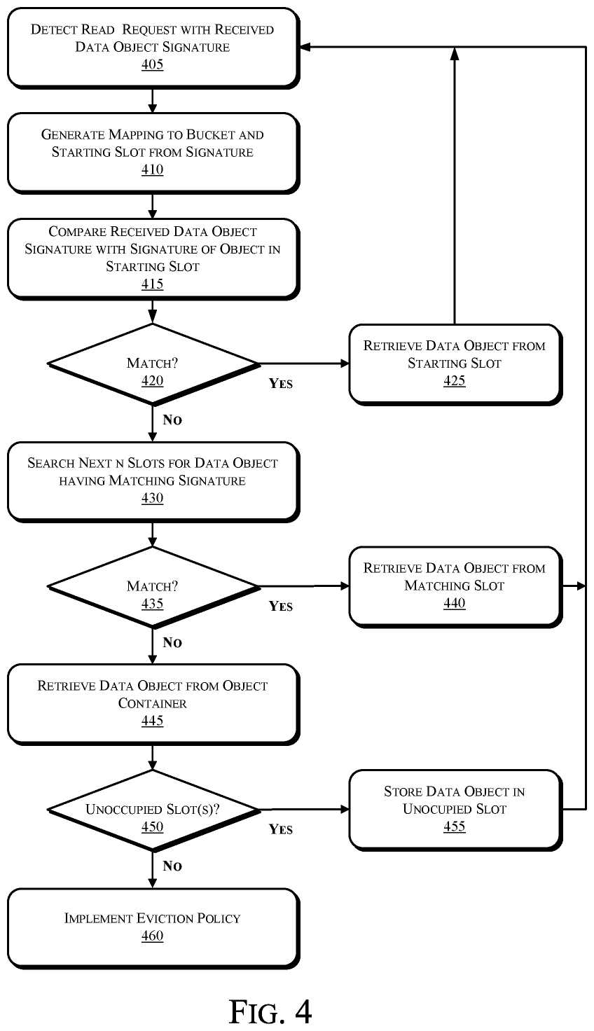

Instruction 338, when executed, causes the processor(s) 320 to selectively manage the input/output (I/O) operation based upon an object signature value associated with the starting slot. Aspects of instructions 332-338 will be explained in greater detail in FIGS. 3B and 4.

FIG. 3B is a flow diagram of a method to implement a recoverable self-validating persistent cache, in accordance with an embodiment. In some embodiments, one or more operations depicted in FIG. 3B may be executed substantially concurrently (i.e., contemporaneously) or in a different order than depicted in FIG. 3B. In some embodiments, a method may include more or fewer operations than are shown. In some embodiments, one or more of the operations of a method may, at certain times, be ongoing and/or may repeat.

The methods described herein may be implemented in the form of executable instructions stored on a machine readable medium and executed by one or more processors and/or in the form of electronic circuitry. For example, the operations may be performed in part or in whole by the controller 310 depicted in FIG. 3A.

Referring to FIG. 3B, at operation 350, an input/output (I/O) request comprising a received object signature that uniquely identifies a data object stored in an object container of the distributed computer system is detected in a storage manager of a node of the distributed computer system. In some examples the input/output (I/O) request may comprise a read request to read data associated with the data object. In some examples detecting the data access request may comprise receiving the data access request in the controller 310. While in other examples the data access request may be detected outside the controller 310.

At operation 355 a first mapping to a bucket in an on-disk cache table, the bucket comprising a predetermined number of slots in the cache table, is generated from a first portion of the received object signature. As described above, in some examples a first hash function 280 may be applied to a segment 214 of the object signature 210 to generate a mapping to a bucket in the cache bucket table 220.

At operation 360 a second mapping to a starting slot in the bucket is generated from a second portion of the received object signature. As described above, in some examples the instructions may cause the processor(s) 320 to apply a second hash function 282 to a segment 216 of the object signature 210 to generate a mapping to a starting slot within the bucket of the hash slot table.

At operation 365 the input/output (I/O) operation is selectively managed based upon an object signature value associated with the starting slot. Aspects of instructions 338 will be explained in greater detail in FIG. 4.

FIG. 4 is a flow diagram of a method to implement a recoverable self-validating persistent cache, in accordance with an embodiment. More particularly, FIG. 4 illustrates operations in a method to manage read operations in a data storage system that implements a recoverable self-validating persistent object cache. Referring to FIG. 4, at operation 405 a read request for a data object which comprises a data object signature is detected. As described above, a read operation may be detected by controller 410. At operation 410 a mapping to a starting slot in the cache slot table 260 is generated. As described above, in some examples a first mapping to a bucket in an on-disk cache table is generated from a first portion of the received object signature and a second mapping to a starting slot in the bucket is generated from a second portion of the object signature received with the read request in operation 405.

At operation 415 the object signature received with the read request in operation 405 is compared with the object signature of the data object in the starting slot. If, at operation 420, the object signature received with the read request in operation 405 matches the object signature of the data object in the starting slot then control passes to operation 425 and the data residing in the starting slot is retrieved to respond to the read request. By contrast, if at operation 420 the object signature received with the read request in operation 405 does not match the object signature of the data object in the starting slot then control passes to operation 430 and a predetermined number (n) of slots are searched, beginning at the starting slot, for a data object which has a signature that matches the object signature received with the read request in operation 405.

If, at operation 435 a data object which has a signature that matches the object signature received with the read request in operation 405 is located, then control passes to operation 440 and the data object which has a signature that matches the object signature received with the read request in operation 405. By contrast, if at operation 435 no data objects which have a signature that matches the object signature received with the read request in operation 405 are located, then control passes to operation 445 and the data object is retrieved from the object container to respond to read request in operation 405.

At operation 450 it is determined whether there are any unoccupied slots in the predetermined number (n) of slots searched in operation 430. If, at operation 450, there are unoccupied slots in the predetermined number (n) of slots searched in operation 430 then control passes to operation 455 and the data object retrieved from the object container is stored in an unoccupied slot. By contrast, if at operation 450 there are no unoccupied slots in the predetermined number (n) of slots searched in operation 430 then control passes to operation 460 and an eviction policy is implemented. In some examples the eviction policy evicts a data object from one of the slots in the predetermined number (n) of slots searched in operation 430 and stores the data record retrieved from the object container in the slot. In some examples the data object may be evicted using one of a least recently used (LRU) eviction policy, a most recently used (MRU) policy, a first-in first-out (FIFO) eviction policy, a last-in first-out (LIFO) policy, a random replacement (RR) policy, or any other suitable eviction policy.

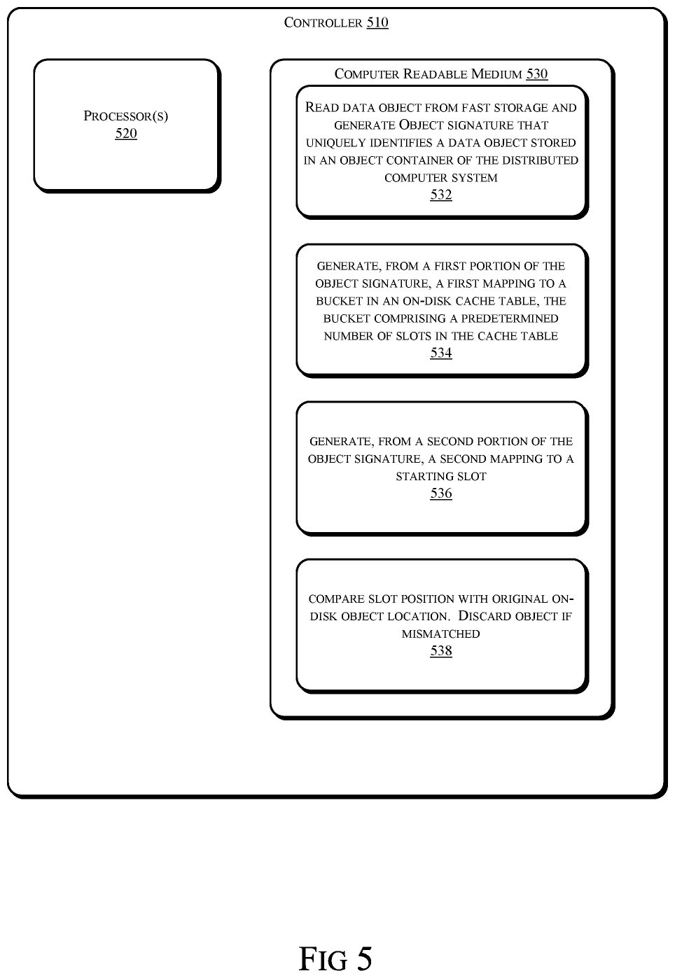

FIG. 5 is a schematic illustration of a machine readable medium comprising instruction to implement recovery operations in a recoverable self-validating persistent cache, in accordance with an embodiment. More particularly, FIG. 5 depicts a controller 510 which comprises one or more processors 520 communicatively coupled to a non-transitory computer-readable medium 530 encoded with instructions 532, 534, 536, 538. The processor(s) 520 may be implemented as a general-purpose processing device, a programmable device (e.g., a field programmable gate array (FPGA)), or as a hard-wired processor (e.g., an application specific integrated circuit (ASIC)). In some examples the controller 510 may be incorporate into, or communicatively coupled to, a storage manager of a node of a distributed computer system.

In some examples the instructions depicted in FIG. 5 may be implemented when a recovery procedure is to be implemented for the fast storage portion of a hybrid storage system. Instructions 532, when executed, cause the processor(s) 520 to read an object (e.g., an 8K data object) from fast storage and generate a signature that uniquely identifies a data object stored in an object container of the distributed storage system. Instructions 534, when executed, cause the processor(s) 520 to generate, from a first portion of the object signature generated by instruction 532, a first mapping to a bucket in an on-disk cache table. In some examples the bucket comprises a predetermined number of slots in the cache table. Instructions 536, when executed, cause the processor(s) 520 to generate, from a second portion of the object signature, a second mapping to a starting slot. In some examples the on disk location (i.e., the LBA) for each object may be directly calculated from table position by just multiplying by the object size. In other words the table position matches the object's block number on cache disk. Instructions 538, when executed, cause the processor(s) 520 to compare the slot position with the original on-disk data object location, and to discard the object if there is a mismatch between the slot position and the original on-disk object location.

In some instances, when a storage system is restarted (for example, due to an upgrade or error handling activity) a read cache may be recovered, or it may be discarded. If the read cache is not recovered, a new read cache must be built up from subsequent read operations, which negatively impacts read performance while the read cache is being reconstructed. By contrast, if the read cache is recovered then the in-memory cache data structures are rebuilt from the on-disk object data at startup which offers read cache optimization nearly immediately.

The recovery process generally involves generating object signatures from the on-disk data followed by an object validation to ensure the signature corresponds to a real object in the system. In some examples this may be done using the master index. However, lookups are computationally expensive and time-consuming.

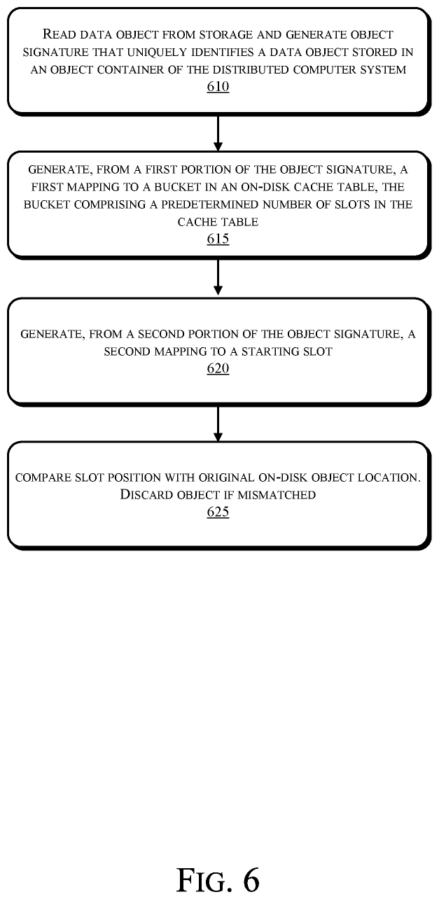

FIG. 6 is a flow diagram of a method to implement recovery operations in a recoverable self-validating persistent cache, in accordance with an embodiment. In some embodiments, one or more operations depicted in FIG. 6 may be executed substantially concurrently (i.e., contemporaneously) or in a different order than depicted in FIG. 3B. In some embodiments, a method may include more or fewer operations than are shown. In some embodiments, one or more of the operations of a method may, at certain times, be ongoing and/or may repeat.

The methods described herein may be implemented in the form of executable instructions stored on a machine readable medium and executed by one or more processors and/or in the form of electronic circuitry. For example, the operations may be performed in part or in whole by the controller 510 depicted in FIG. 5.

Referring to FIG. 6, at operation 610 an object (e.g., an 8K data object) is read from storage and an object signature that uniquely identifies a data object stored in an object container of the distributed storage system is generated. In some examples the signature may be a secure hash algorithm (SHA) signature.

At operation 615 a first mapping to a bucket in an on-disk cache table is generated from a first portion of the object signature generated in operation 610. In some examples the bucket comprises a predetermined number of slots in the cache table. At operation 620 a second mapping to a starting slot is generated from a second portion of the object signature. In some examples the on disk location (LBA) for each object may be directly calculated from table position by multiplying by the object size. In other words the table position matches the object's block number on cache disk. At operation 625 the slot position is compared with the original on-disk data object location, and the object is discarded if there is a mismatch between the slot position and the original on-disk object location.

The techniques illustrated in FIG. 6 provide a computationally inexpensive and fast method to validate by object position, since the hashing algorithm results in a slot position that correlates to a single on-disk position (LBA). If the LBA does not match the slot position then the data object is not recovered into the read cache and may be discarded. Furthermore, because the techniques in FIG. 6 provide a computationally inexpensive and fast method to validate data objects, it is not critical that the data objects were not consistently placed into storage (e.g., due to sudden termination during a write operation). If a data object is corrupted or partially written, then it is not included in the cache. This allows for the use of non-redundant storage (e.g., no raid protection) which yields better storage utilization. Also, it may be used in conjunction with I/O cache buffering optimizations which helps speed up recovery data access.

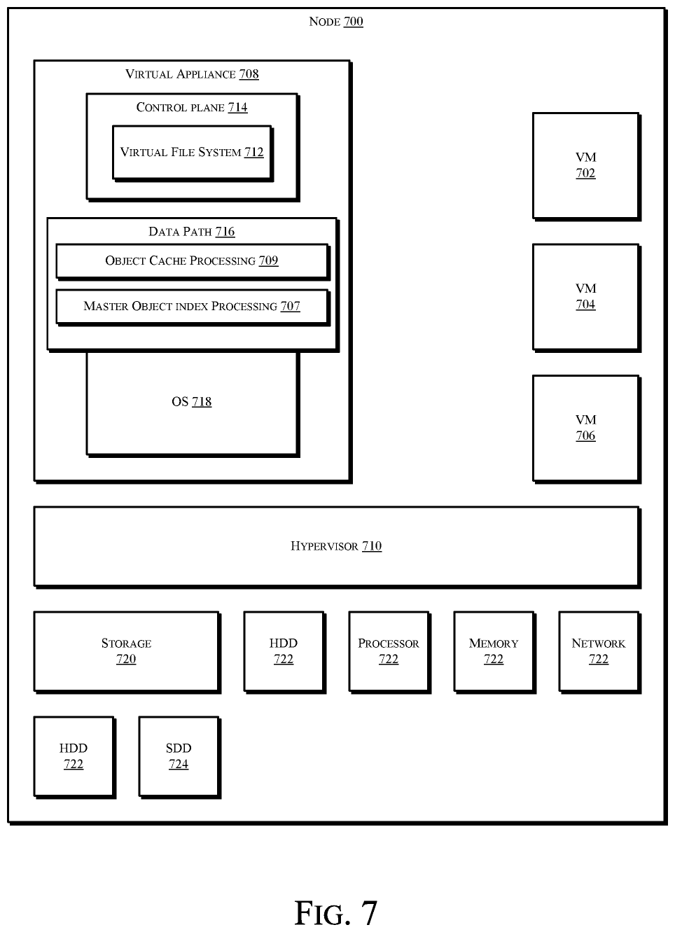

FIG. 7 is a block diagram illustrating a HyperConverged Infrastructure (HCI) node 700 that may represent the nodes of a distributed system in accordance with an embodiment. In the context of the present example, node 700 has a software-centric architecture that integrates compute, storage, networking and virtualization resources and other technologies. For example, node 700 can be a commercially available system such as HPE SimpliVity 380 incorporating an OnmiStack® file system available from Hewlett Packard Enterprise of San Jose, Calif.

Node 700 may be implemented as a physical server (e.g., a server having an x86 or x64 architecture) or other suitable computing device. In the present example, node 700 hosts a number of guest virtual machines (VM) 702, 704 and 706, and can be configured to produce local and remote backups and snapshots of the virtual machines. In some embodiments, multiple of such nodes, each performing object cache processing 709 and master object index processing 707 (such as that described above), may be coupled to a network and configured as part of a cluster. Depending upon the particular implementation, one or more services supported by the distributed system may be related to VMs 702, 704 and 706 or may be unrelated.

Node 700 can include a virtual appliance 708 above a hypervisor 710. Virtual appliance 708 can include a virtual file system 712 in communication with a control plane 714 and a data path 716. Control plane 714 can handle data flow between applications and resources within node 700. Data path 716 can provide a suitable Input/Output (I/O) interface between virtual file system 712 and an operating system (OS) 718, and can also enable features such as data compression, deduplication, and optimization. According to one embodiment the virtual appliance 708 represents a virtual controller configured to run storage stack software (not shown) that may be used to perform functions such as managing access by VMs 702, 704 and 706 to storage 720, providing dynamic resource sharing, moving VM data between storage resources 722 and 724, providing data movement, and/or performing other hyperconverged data center functions.

Node 700 can also include a number of hardware components below hypervisor 710. For example, node 700 can include storage 720 which can be Redundant Array of Independent Disks (RAID) storage having a number of hard disk drives (HDDs) 722 and/or solid state drives (SSDs) 724. Node 700 can also include memory 726 (e.g., RAM, ROM, flash, etc.) and one or more processors 728. Lastly, node 700 can include wireless and/or wired network interface components 130 to enable communication over a network (e.g., with other nodes or with the Internet).

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A processor-based method to manage data objects in a distributed computer system, the method comprising:
detecting, in a storage manager of a node of the distributed computer system, an input/output (I/O) request comprising a received object signature that uniquely identifies a data object stored in an object container of the distributed computer system;
generating, from a first portion of the received object signature, a first mapping to a bucket in an on-disk cache table, the bucket comprising a predetermined number of slots in the on-disk cache table;
generating, from a second portion of the received object signature, a second mapping to a starting slot of the bucket; and
selectively managing the input/output (I/O) operation based upon an object signature value associated with the starting slot of the bucket.

2. The method of claim 1 wherein the input/output (I/O) operation is a read operation, further comprising:
in response to a determination that the starting slot comprises a data object having a signature value that matches the signature value of the received data object, retrieving the data object from the starting slot.

3. The method of claim 1, wherein the input/output (I/O) operation is a read operation, further comprising:
in response to a determination that the starting slot comprises a data object having a signature value that does not match the signature value of the received data object, scanning, beginning at the starting slot, a predetermined number of slots.

4. The method of claim 3 wherein the input/output (I/O) operation is a read operation, further comprising:
in response to a determination that a selected slot in the predetermined number of slots comprises a stored object signature that matches the received object signature, retrieving the data object from the selected slot.

5. The method of claim 4 wherein the input/output (I/O) operation is a read operation, further comprising:
in response to a determination that there is not a slot in the predetermined number of slots which comprises a stored object signature that matches the received object signature:
retrieving the data object from the object container; and
in response to a determination that a slot in the predetermined number of slots is unoccupied, storing the data object from the object container in a slot of the predetermined number of slots.

6. The method of claim 4, wherein the input/output (I/O) operation is a read operation, further comprising:
in response to a determination that there is not a slot in the predetermined number of slots which comprises a stored object signature that matches the received object signature:
retrieving the data object from the object container; and
in response to a determination that no slot in the predetermined number of slots is unoccupied:
locating an occupied slot in the predetermined number of slots;
evicting a data object from the occupied slot; and
storing the copy of the data object in the occupied slot.

7. A system, comprising:
one or more processors; and
a computer-readable storage medium comprising logic instructions which, when executed by the one or more processors, configure the one or more processors to perform operations comprising:
detecting, in a storage manager of a node of the distributed computer system, an input/output (I/O) request comprising a received object signature that uniquely identifies a data object stored in an object container of the distributed computer system;
generating, from a first portion of the received object signature, a first mapping to a bucket in an on-disk cache table, the bucket comprising a predetermined number of slots in the on-disk cache table;
generating, from a second portion of the received object signature, a second mapping to a starting slot of the bucket; and
selectively managing the input/output (I/O) operation based upon an object signature value associated with the starting slot of the bucket.

8. The system of claim 7, the computer-readable storage medium comprising logic instructions which, when executed by the one or more processors when the input/output (I/O) operation is a read operation, configure the one or more processors to perform operations comprising:
in response to a determination that the starting slot comprises a data object having a signature value that matches the signature value of the received data object, retrieving the data object from the starting slot.

9. The system of claim 7, the computer-readable storage medium comprising logic instructions which, when executed by the one or more processors when the input/output (I/O) operation is a read operation, configure the one or more processors to perform operations comprising:
in response to a determination that the starting slot comprises a data object having a signature value that does not match the signature value of the received data object, scanning, beginning at the starting slot, a predetermined number of slots.

10. The system of claim 9, the computer-readable storage medium comprising logic instructions which, when executed by the one or more processors when the input/output (I/O) operation is a read operation, configure the one or more processors to perform operations comprising:
in response to a determination that a selected slot in the predetermined number of slots comprises a stored object signature that matches the received object signature, retrieving the data object from the selected slot.

11. The system of claim 10, the computer-readable storage medium comprising logic instructions which, when executed by the one or more processors when the input/output (I/O) operation is a read operation, configure the one or more processors to perform operations comprising:
in response to a determination that there is not a slot in the predetermined number of slots which comprises a stored object signature that matches the received object signature:
retrieving the data object from the object container; and
in response to a determination that a slot in the predetermined number of slots is unoccupied, storing the data object from the object container in a slot of the predetermined number of slots.

12. The system of claim 12, the computer-readable storage medium comprising logic instructions which, when executed by the one or more processors when the input/output (I/O) operation is a read operation, configure the one or more processors to perform operations comprising:
in response to a determination that the starting slot is unoccupied, writing the data object to the starting slot.

13. A processor-based method to implement recovery operations for a read cache in a distributed computer system, the method comprising:
reading a data object from an on-disk object location;
generating an object signature that uniquely identifies the data object;
generating, from a first portion of the received object signature, a first mapping to a bucket in an on-disk cache table, the bucket comprising a predetermined number of slots in the on-disk cache table;
generating, from a second portion of the received object signature, a second mapping to a starting slot of the bucket; and
comparing the starting slot position with the on-disk object location to determine whether the data object is a valid object.

14. The method of claim 13, wherein the object signature comprises a secure hash algorithm (SHA) signature.

15. The method of claim 13, further comprising:
discarding the data object when there is a mismatch between the starting slot position and the on-disk object location.

16. The method of claim 13, further comprising:
validating the data object when there is a match between the starting slot position and the on-disk object location.

17. A system, comprising:
one or more processors; and
a computer-readable storage medium comprising logic instructions which, when executed by the one or more processors, configure the one or more processors to perform operations comprising:
reading a data object from an on-disk object location;
generating an object signature that uniquely identifies the data object;
generating, from a first portion of the received object signature, a first mapping to a bucket in an on-disk cache table, the bucket comprising a predetermined number of slots in the on-disk cache table;
generating, from a second portion of the received object signature, a second mapping to a starting slot of the bucket; and
comparing the starting slot position with the on-disk object location to determine whether the data object is a valid object.

18. The system of claim 17, wherein the object signature comprises a secure hash algorithm (SHA) signature.

19. The system of claim 17, the computer-readable storage medium comprising logic instructions which, when executed by the one or more processors, configure the one or more processors to perform operations comprising:
discarding the data object when there is a mismatch between the starting slot position and the on-disk object location.

20. The system of claim 17, the computer-readable storage medium comprising logic instructions which, when executed by the one or more processors, configure the one or more processors to perform operations comprising:
validating the data object when there is a match between the slot position and the on-disk object location.
